(19) United States
(12) Patent Application Publication
(10) Pub. No.: US 2013/0054287 A1
(43) Pub. Date: Feb. 28, 2013

(54) VEHICLE DEALERSHIP CUSTOMER SERVICE AND RETENTION UTILITY

(71) Applicants: Mario Rivera, Lutz, FL (US); Jason Kuhn, Tampa, FL (US); Derrick Fish, Land O Lakes, FL (US); Matthew Rogerson, Tampa, FL (US)

(72) Inventors: Mario Rivera, Lutz, FL (US); Jason Kuhn, Tampa, FL (US); Derrick Fish, Land O Lakes, FL (US); Matthew Rogerson, Tampa, FL (US)

(73) Assignee: TMD DEALER SOLUTIONS, LLC, Tampa, FL (US)

(21) Appl. No.: 13/221,490

(22) Filed: Aug. 30, 2011

(51) Int. Cl. G06Q 10/00

(52) U.S. Cl. 705/7.12; 705/305

(57) ABSTRACT

The invention provides a convenient platform in the form of a dealership utility through which customers and dealers can manage vehicles and service appointments. Customers may log-in to access a customer module of the dealership utility through which they may receive notifications pertaining to their vehicle, view vehicle status information, adjust their preferences and settings, schedule and manage service appointments, contact the dealership and view service histories associated with their vehicles. Dealers may log-in to access a dealer module of the dealership utility through which they may manage employees, customers and service appointments, as well as review customer surveys and business reports. The dealership utility may be implemented as a web application, software application, or mobile application, and/or in combination with a text messaging system, usable by customers and dealers on any computing device such as personal computers and mobile phones.

### FIELD OF INVENTION

This invention relates generally to mobile and web applications and more specifically to a web-based utility for facilitating the provision of dealership services to customers.

### BACKGROUND OF THE INVENTION

Millions of people buy vehicles from a variety of vehicle dealerships, and vehicle owners know that vehicles need to be serviced regularly to maintain performance and operability. However, remembering when to service vehicles, what services are needed, scheduling vehicle service appointments, and taking the vehicle to a dealership or other service facility is often a source of annoyance and inconvenience to vehicle owners, and forgetting to bring a vehicle in for recommended maintenance servicing may cause irreparable damage to the vehicle.

Conventionally, vehicle owners and operators generally need to consult owner's manuals, online resources, or rely on word of mouth to figure out when their vehicles should generally be serviced, and need to rely on memory, stickers placed on their windshield or mailed paper reminders to remember to actually bring their vehicles to a dealership or other service facility for those maintenance services.

Dealerships also often struggle to retain customers that bought vehicles at the dealership as regular service customers, as the customer often arbitrarily chooses other service facilities to perform maintenance on their vehicles. Additionally, because vehicle owners often take their vehicles to various different service facilities, no one facility has a complete record of the vehicle's service history. Vehicle owners often end up forgetting what type of service was performed and/or when it was performed, when additional services will be needed, and may also completely forget to bring their vehicles in for services.

The inventors have created the above body of information merely for the convenience of the reader; the foregoing is a discussion of problems discovered and/or appreciated by the inventors, and is not an attempt to review or catalog the prior art.

### BRIEF SUMMARY OF THE INVENTION

The invention provides a convenient platform in the form of a dealership utility through which customers and dealers can manage vehicles and service appointments. In one embodiment, the dealership utility provides dealership services to customers through: receiving, at a computing device, log-in information corresponding to a customer of the dealership; estimating, at the computing device, a distance traveled corresponding to a vehicle associated with the customer according to a database at the dealership utility system; determining, at the computing device, a next service due time based on the estimated distance traveled; notifying, from the computing device, the customer at a predetermined time prior to the determined next service due time of when the vehicle is due for a service; and receiving, at the computing device, an input from the customer corresponding to scheduling of a service appointment in response to the notification. The customer may also be notified of scheduled service appointments at predetermined times prior to the scheduled service appointments.

The estimation of a distance traveled may be based on receiving, at the computing device, at least two distance traveled inputs corresponding to the distance traveled corresponding to the vehicle, wherein the at least two distance traveled inputs are received at different times; calculating, at the computing device, a predictive distance over time rate based on the at least two distance traveled inputs and the times at which the at least two distance traveled inputs were received; and applying the predictive distance over time rate to one of an estimated distance traveled and a received distance traveled input. In an alternative embodiment, the estimated distance traveled may be based on applying a default distance over time rate to a previously stored distance traveled value corresponding to the vehicle.

The computing device may communicate vehicle status including estimated distance traveled and when the next service should be due to the customer, as well as communicating information corresponding to future scheduled service appointments and past services performed pertaining to the vehicle. The computing device may be any type of computing device with appropriate capabilities and programming, such as a personal computer, tablet computer, a mobile phone, and an application server. It will be appreciated that the above described steps may also be embodied as computer-executable instructions stored on at least one tangible, non-transient computer-readable medium.

The dealership utility may be a networked system—including at least one web server, application server, and database—that provides a variety of interfaces organized through a customer module and a dealer module to customers and dealers accessing the utility over a network from various computing devices. Customers may access a vehicle status interface to view vehicle information, a notifications interface for receiving notifications regarding vehicles, and a customer appointments interface for scheduling service appointments. Dealers may access a customers interface for managing customers and a dealer appointments interface for managing appointments. The appointments scheduled through the customer appointment interface and dealer appointment interface may be synchronized such that updates to one are automatically updated in the other.

In further embodiments, dealers may further access an employees interface for managing employees, a surveys interface for reviewing survey results received from customers, and a reports interface for viewing reports relating to dealer activities. The dealership utility may further include customer and dealer log-in interfaces.

Other objects and advantages of the invention will become apparent upon reading the following detailed description and upon reference to the drawings.

### BRIEF DESCRIPTION OF THE SEVERAL VIEWS OF THE DRAWING(S)

FIG. 1 is a schematic diagram of an exemplary operating environment for a networked dealership utility system usable in embodiments of the described principles;

FIG. 2 is a flowchart illustrating the relationship between various interfaces of a dealership utility and the customer and dealer modules of the dealership utility according to an embodiment of the described principles;

FIG. 3 is an example of a display corresponding to a vehicle status interface of the customer module of the dealership utility according to an embodiment of the described principles;

FIG. 4 is an example of a display corresponding to a notification interface of the customer module of the dealership utility according to an embodiment of the described principles; and

FIG. 5 is an example of a display corresponding to an employees interface of the dealer module of the dealership utility according to an embodiment of the described principles.

### DETAILED DESCRIPTION OF THE INVENTION

Before discussing the details of the invention and the environment wherein the invention may be used, a brief overview is given to guide the reader. In general terms, not intended to limit the claims, the invention is directed to a dealership customer service and retention utility for vehicle dealerships, including a web application (or other software application) and/or a mobile application. The invention provides a convenient platform, accessible by a vehicle owner or operator, i.e., a “customer,” through which the customer can keep track of the status of one or more vehicles, receive notifications regarding recommended service times, schedule service appointments, contact a dealership, and more. Additionally, using this platform, dealerships will be able to stay in touch with their customers, provide customized recommendations and promotions to them, keep track of scheduled appointments and billing, as well as manage their employees. By using this dealership customer service and retention utility, both customers and dealerships benefit from increased convenience, better vehicle maintenance, and higher customer retention rates.

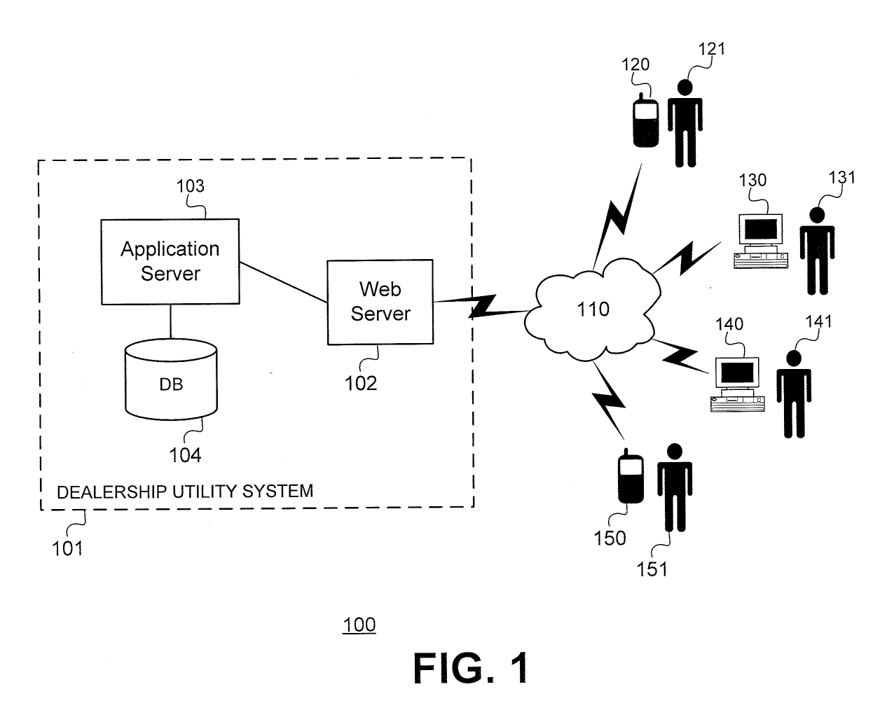

Given this overview, an exemplary environment in which the invention may operate is described hereinafter. It will be appreciated that the described environment is an example, and does not imply any limitation regarding the use of other environments to practice the invention. With reference to FIG. 1 there is shown an example of a system 100 for implementing the described dealership customer service and retention utility (referred to hereinafter as the “dealership utility”). In the depicted embodiment, the dealership utility is implemented at a dealership utility system 101 connected to a network 110 (e.g., the Internet). The dealership utility system 101 comprises at least one web server 102 for delivering and receiving content over the network, at least one application server 103 for executing back end programming logic, and at least one database 104 for storing data and/or instructions that may be accessed by the application server 103. Although the teems “web server,” “application server,” and “database” are used herein in describing the illustrative exemplary system, it will be appreciated that the function of such devices may be served by other devices in alternative embodiments. For example, general purpose computing devices may be configured to act as a web server, application server, or database with appropriate programming or software.

A plurality of users 121, 131, 141, and 151 may access the dealership utility over the network 110 through computing devices 120, 130, 140 and 150. The users may be customers that purchased their vehicle from dealerships registered with the dealership utility as well as managers and employees of the dealerships. The computing devices may be personal computers, laptops, tablet computers, PDAs, smartphones, other types of mobile phones, etc. It will be appreciated that the dealership utility may be presented to the user on the computing devices as a web application accessed through a browser, through a software application on the computing device, or, particularly for smartphones, through a mobile application installed at the smartphone. It will be appreciated that, within the context of the disclosure herein, web application refers to a utility implemented on a networked computing system accessible by user computing devices over the Internet (e.g. through browsers) wherein the bulk of the processing takes place at the networked computing system, mobile applications refer to applications installed on smartphones that may communicate with a networked computing system, and a “software” application refers generally to applications other than web browsers installed on other types of user computing devices that may communicate with a networked computing system over a network.

It will further be appreciated by those of skill in the art that the execution of the various machine-implemented processes and steps described herein may occur via the computerized execution of computer-executable instructions stored on one or more tangible, non-transient computer-readable media, e.g., RAM, ROM, PROM, volatile, nonvolatile, or other electronic memory mechanism. Thus, for example, operations performed by users at their computing devices 120, 130, 140, 150 may be carried out according to stored instructions or applications installed at the computing devices, and operations performed at the dealership utility system 101 may be carried out according to stored instructions or applications installed at the web server 102, application server 103 or database 104. In certain implementations, it may be advantageous to perform the bulk of the processing described herein at the computing devices 120, 130, 140, and 150, and in other implementations it may be advantageous to simply use the computing devices 120, 130, 140, and 150 as user interfaces with the bulk of the processing at the application server 103, depending on efficiency considerations and the capabilities of the computing devices 120, 130, 140, and 150 and the application server 103 and web server 102. For example, in one implementation, user interface templates may be provided by a software application or mobile application at the computing devices, but the information regarding vehicles, customers, appointments, etc. is received from the networked dealership utility system 101. In another implementation, a web browser may retrieve all the information, including the interface templates themselves, from the networked dealership utility system 101. In yet another alternative implementation, the user computing device may store the vehicle status information, perform calculations, and determine when services are due, and merely transmits and receives certain information to and from the networked dealership utility system 101 such as receiving available timeslots for service appointments and transmitting scheduled appointments and updates to vehicle or customer account information.

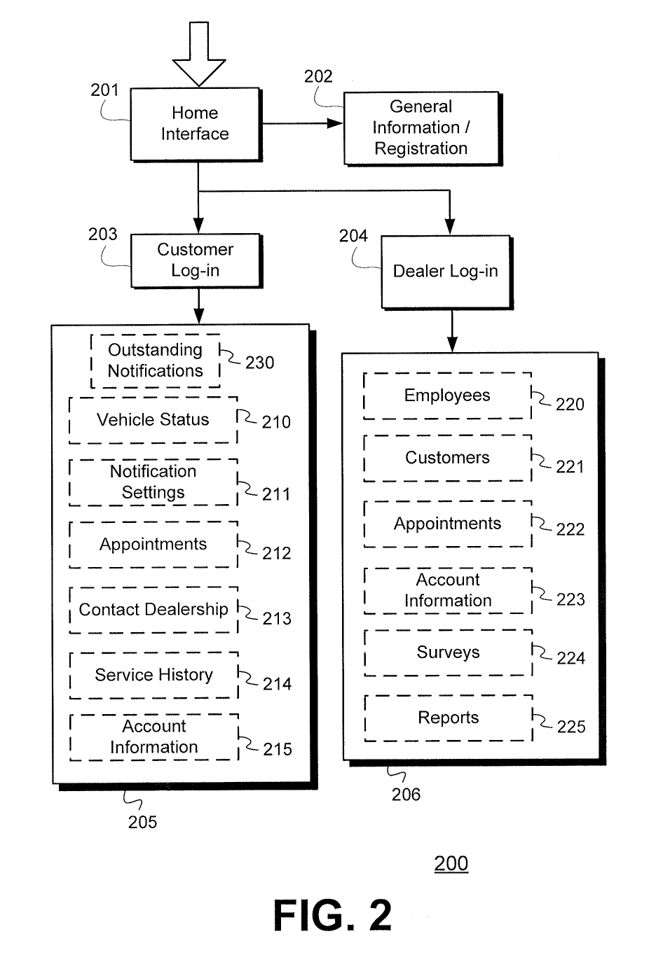

With further reference to the architecture of FIG. 1, and turning more specifically to FIG. 2, a flowchart 200 illustrating the organization of the dealership utility and various interfaces included therein is depicted. Embodiments of the dealership utility implemented as a web application, software applications, or mobile applications will have a home interface 201, which may be a homepage presented to a user accessing the top-level web address for web applications presented to a user in a browser or a welcome screen for software and mobile applications. This home interface 201 may include links to a customer log-in interface 203, a dealer log-in interface 204, or general information about the dealership utility and the option to register as a customer or dealer 202. It will be appreciated that the presentation of a home interface 201 may not be necessary, for example, if a user bypasses it by directly inputting a web address corresponding to a customer log-in page or dealer log-in page, or if a separate mobile application is designed for customers and dealers. It will further be appreciated that the log-in interfaces may be presented as a part of the home interface 201, and that separate customer and dealer log-in interfaces may not be necessary, as the dealership utility may be able to determine whether a user is a customer or a dealer based on the log-in information (e.g., based on the account information corresponding to the inputted user name).

If a new user wishes to register to use the dealership utility, the new user may navigate from the home interface of the dealership utility (whether implemented as a web application, software application, or mobile application) to a registration interface by, for example, clicking a link that says “Register” or “Sign up.” The user may then fill out a form that includes whether the user is a customer or affiliated with a dealership (i.e. a “dealer”) and appropriate registration information (such as desired user name, password, contact information, vehicle information, dealership information, etc.). This information may then be stored at the database 124 as a new user account. New users may also be invited into usage of the dealership utility through electronic invites from the dealership utility or manually entered by dealership personnel with appropriate access permissions to do so. Once the appropriate registration information is entered into the system, the dealership utility may notify the customer electronically (e.g. through email or text) of their user name and password for accessing the dealership utility. The new user may then review and accept a set of Terms and Conditions associated with the dealership utility to gain access to the dealership utility through the customer log-in interface 203.

Assuming that the new user is a customer, the user can then access the customer log-in interface 203, fill out the log-in information corresponding to the user's account, and indicate that the user wishes to sign in. The dealership utility then verifies whether the received log-in information is valid, and, if it is, presents a customer module 205 to the user that provides a variety of customer-related functions and corresponding interfaces to the user. Similarly, if the new user is a dealer, the user can access the dealer log-in interface 204, fill out the log-in information, and sign in. The dealership utility then verifies the validity of the log-in information and presents a dealer module 206 to the user providing a variety of dealer-related functions and interfaces to the user. It will be appreciated that any conventional registration and log-in techniques for web applications, software application, and mobile applications may be used for bringing a user to the customer module 205 or the dealer module 206, whichever is appropriate for the user.

Referring now to the customer module 205, a user may check on or update the status of one or more vehicles (210); adjust notifications settings (211); view currently scheduled appointments, past appointments, or schedule new appointments (212); view contact information for a dealership, contact the dealership, or request roadside assistance (213); view or update the service history of one or more vehicles (214); and view or modify the user's account information (215). It will be appreciated that when the user logs in to the customer module 205, the vehicle status interface (210) may appear first as the default starting interface, but this is not a requirement as any interface or another type of home screen may be used. In a preferred embodiment, if the user has any outstanding notifications, an outstanding notifications interface 230 may be displayed first upon sign-in (e.g., indicating the details of the notification and presenting the user with an option to schedule an appointment or snooze the notification). It will further be appreciated that each interface may include links to the other interfaces. For mobile applications in particular, because display space is generally limited on mobile devices, the links may be presented as small icons or through a separate menu page through which each individual interface may be accessed.

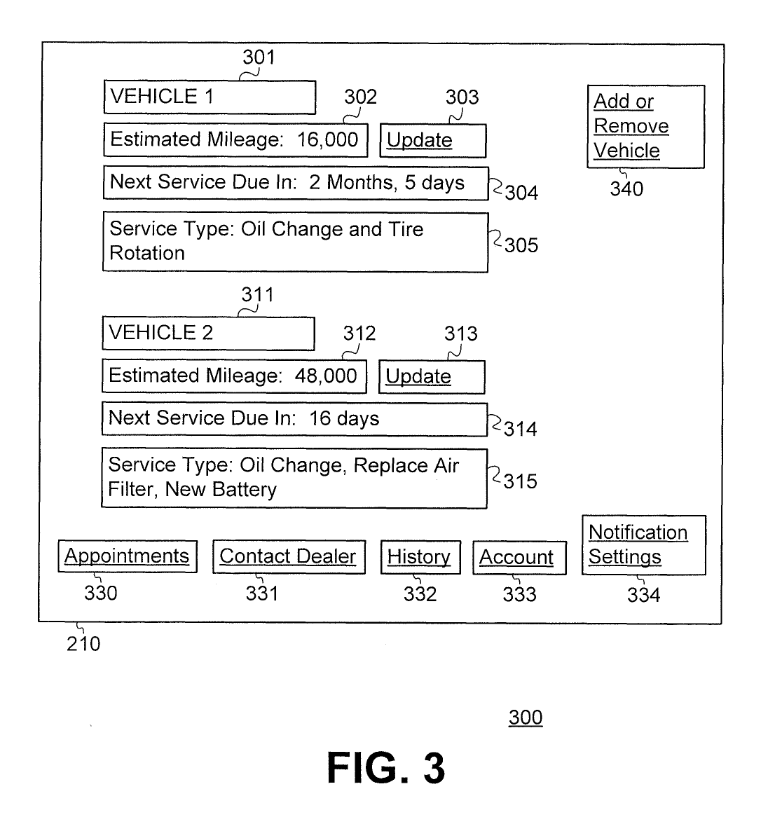

FIG. 3 depicts an exemplary diagram 300 illustrating an example of the appearance of a vehicle status interface (210) displayed to a user. The display area of the vehicle status interface (210) may be contained within a browser window, a software display window, or a smartphone screen. As shown in FIG. 3, for a first vehicle, VEHICLE 1, the vehicle status interface may include an identification of the vehicle 301 (e.g., a user-assigned name or the vehicle year, make and model or VIN, etc.), an estimated mileage for that vehicle 302, an option to update the estimated mileage 303 with a user-input vehicle mileage (e.g., clicking on the update button may prompt the user to enter the current mileage of VEHICLE 1), an indication of when the next service will be due 304, and an indication of what services need to be performed 305. The vehicle status interface (210) may further include the name 311, estimated mileage 312, option to update mileage 313, indication of next service due 314, and indication of services needed 315 corresponding to a second vehicle 305 (“VEHICLE 2”). It will be appreciated that any number of vehicles may be included in the vehicle status interface, and if the display area is not large enough, not all of the vehicles' statuses need to be displayed simultaneously. For example, in this embodiment, for three or more vehicles, a scroll bar may be used.

The vehicle status interface (210) may also include an add or remove vehicle option 340 that brings the user to another interface where the user can input the information corresponding to additional vehicles or choose to remove vehicles that are currently associated with the user's account. For example, the user may click or otherwise select the “add or remove vehicle” button 340, choose to add a vehicle (e.g., “VEHICLE 3”), enter vehicle information such as name, make, model, year, VIN, current mileage, etc. into an appropriate input form, and then the user's account will have three vehicles associated with it, and the vehicle status interface (210) will present the status information corresponding to three vehicles.

The estimated mileages 302 and 312 for each vehicle may be based on a default distance/time (i.e. distance over time) rate set by the dealership utility, and in a further embodiment, a predictive distance/time rate calculated by the dealership utility based on user updates of the estimated mileage (303 and 313). For example, assume that VEHICLE 1 was added to the user's account with an initial mileage of 5,000 miles and that the default distance/time rate is 27 miles per day. Given this assumption, if the customer checks the vehicle status interface (210) one day after VEHICLE 1 is added to the system with 5,000 miles, the estimated mileage 302 for VEHICLE 1 is 5,027 miles. In a further embodiment, now assume that the customer had actually only driven 20 miles that first day, and the customer chooses to update the estimated mileage 303 of VEHICLE 1 to 5,020 miles (the actual mileage of VEHICLE 1). The dealership utility may then calculate a predictive distance/time rate of 20 miles/day for VEHICLE 1 and associate that predictive estimated distance/time rate specifically with VEHICLE 1. The predictive distance/time rate may be used for subsequent mile estimations (302) and may be updated each time the user updates the estimated mileage of VEHICLE 1 (303).

It will be appreciated that many variations of a predictive estimated distance/time rate may be implemented: for example, a minimum time period may be set between an initial input of mileage and an update of mileage for calculation purposes to ensure adequate sample size; the calculation may be between the earliest input of mileage and the latest update of mileage so that the calculation better reflects overall driving habits; the calculation may be between the two latest updates of mileage so that the calculation better reflects recent driving habits; the calculation may further take into account the days of the week to reflect possible commuting habits on weekdays; and the calculation may ignore abnormalities such as spikes in mileage over a short period which may correspond to a vacation; etc. In another embodiment, the user may also manually set a distance/time rate or a method of calculation to be used with respect to a certain vehicle.

The determination of when the next service is due 304 and 314 may be based on the mileage, the default or predictive distance/time rate, and stored information regarding recommended service times. For example, consider an exemplary embodiment of the dealership utility that only tracks when oil changes are due. There are many possible ways of setting a due date for the next oil change. In one embodiment, when the user adds a vehicle to the user account, the dealership utility may ask the user for input regarding when the last time or what the last mileage at which the user had the vehicle's oil changed was. The dealership then stores this information and may set a next oil change date based on the last time the vehicle's oil was changed, the starting mileage of the vehicle and a stored recommended mileage interval. For example, if the starting mileage of the vehicle is 10,000 miles, the last time the vehicle had the oil changed was at 9,000 miles, and the recommended service interval for oil changes is 3,000 miles, the next recommended service mileage for an oil change would be at 12,000 miles. Using the default or predictive distance/time rate, the date on which the next service is due (or the number of days until which the next service is due) may be calculated from the date at which the vehicle's mileage is 10,000 and the date at which the vehicle's mileage is expected to reach 13,000. This service due date (or remaining number of days) may be recalculated when the mileage is updated, such that if the user is driving more than is estimated by the default or predictive distance/time rate and the user updates the mileage, the next service due date may be adjusted to be sooner based on the updated mileage.

It will be appreciated that in other embodiments, more than just oil change services may be tracked. For example, the dealership utility may track oil changes, tire rotations, battery replacements, general check-up times, and other routine maintenance matters, and store separate service intervals for each. It will further be appreciated that the user may not be required to input the last service date or mileage for each of these items. For example, the dealership utility may set a default initial check-up time after the user adds a vehicle to the system, and if the user brings the vehicle in for the initial check-up, the dealership may be able to determine approximately when services will be needed and may use the dealer interface to set a number of service due dates or intervals corresponding to the user's vehicle. In another example, the dealership utility may have predetermined mileages at which certain events occur (e.g., setting a battery change to be due at 48,000 miles and 96,000 miles; tire rotations to be due at 6,000 miles and every 6,000 miles after that; and oil changes to be due at 3,000 miles and every 3,000 miles after that). The dates (or days remaining) on which these services are due may be calculated based on the current estimated or updated mileage of the vehicle as described above.

The vehicle status interface (210) further includes buttons that allow a user to access other interfaces, such as an appointments button 330 that allows the user to access an appointments interface (212) for viewing and scheduling appointments; a contact dealer button 331 that allows the user to access a contact dealer interface (213) for contacting the dealer; a history button 332 that allows the user to access a service history interface (214) that allows a user to view their service history; an account button 333 that allows the user to access an account information interface (215) that allows the user to view and modify their account information; and a notifications button 334 that allows the user to access a notification settings interface (211) that allows a user to view and modify certain notification settings. It will be appreciated that other interface may include a “vehicle status” button for accessing the vehicle status interface (210), and that these buttons providing access to the various interfaces may be incorporated into any of the interfaces described herein to provide a convenient means of navigation to the user. It will further be appreciated that in another embodiment, the vehicle status interface itself may include a “vehicle status” button in addition to all the other buttons such that a consistent set of buttons is presented to the user in each interface.

It will be appreciated that the layout of the presentation of information through the vehicle status information may vary in different embodiments of the dealership utility, that not all the content depicted in FIG. 3 need be included, and that for mobile applications in particular a more space-saving design may be preferred. For example, separate display screens may be used for each vehicle, and the user may have to switch between vehicles (e.g. through a “switch vehicle” button or similar means) to access the status information, appointments, history, and notification settings for each vehicle separately. In other exemplary embodiments, the mileage may instead be an estimated distance traveled in kilometers, and the next service due may be represented as simply a number of days remaining, or as a date (rather than in terms of months and days remaining as depicted in FIG. 3). It will further be appreciated that icons or graphics can be used instead of the text links shown in FIG. 3, that the vehicle status interface (and all other interfaces) can include other links as well such as “home,” “help” (to provide instructions for using the dealership utility and/or a customer support number), or “log-off” links, and that interfaces can be combined or subsumed within each other. These types of design variations are readily implementable by one skilled in the art without departing from the disclosure of the inventive principles described herein.

In an exemplary embodiment, the dealership utility is configured to provide notifications to users at two weeks and one day before “next service due” dates and scheduled appointments. It will be appreciated that notifications may be provided for other events as well, such as notifying a customer of when parts that they need to complete a service have arrived or notifying a customer of various promotional deals. These notifications may be sent by e-mail to an e-mail account associated with the user's account (and the user may designate an e-mail at which the user wishes to receive e-mails in the account information interface (215)). These notifications may also be sent by text message to a phone number associated with the user (the phone number may also be designated by the user in the account information interface (215)). Furthermore, as described above, when the user logs in through the customer log-in interface 203 of the dealership utility through a mobile application, web application or software application, any outstanding notifications may be immediately presented to the user through an outstanding notifications interface 230.

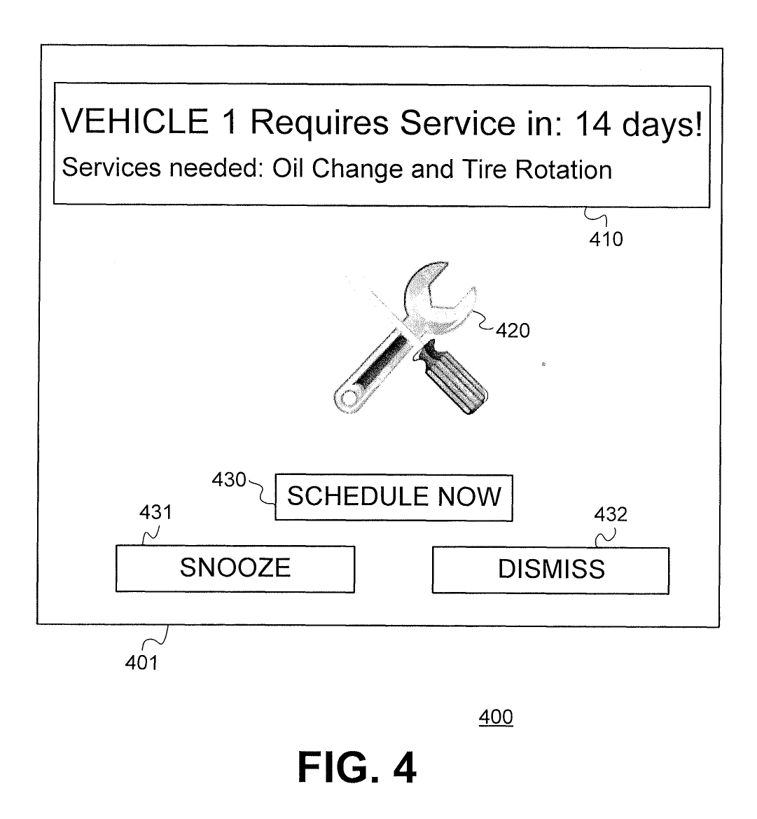

FIG. 4 provides a diagram 400 of an exemplary outstanding notifications interface 401 that may be used with web application, software application, or mobile application implementations of the dealership utility. For example, assume that VEHICLE 1 has an estimated mileage of 11,860 miles, a predictive time/distance rate of 10 miles/day, and an oil change and tire rotation due at 12,000 miles. When a user logs in through the customer log-in interface (203) of the dealership utility, this notification interface 401 will be immediately presented to the user, indicating that VEHICLE 1 requires service in 14 days and further indicating the nature of those services (410). The interface may further include a graphic 420, and various options 430, 431 and 432. For example, the user may choose to schedule the service 430, may snooze the notification 431, or may dismiss the notification 432 by clicking the corresponding buttons.

If the user chooses to schedule the service 430, the dealership utility may present the schedule service interface to the user (which may be the appointments interface (212) or a separate schedule service interface accessible from the appointments interface (212)). This schedule service interface may, for example, include a calendar with dates, and by clicking on various dates, the user may view the availability of service appointments on those dates and reserve a time (and may further specify the nature of the services being scheduled when reserving the service time). The schedule service interface may also provide other ways of scheduling the service, such as by providing a phone number (and a link to directly call the dealership in mobile application implementations of the dealership utility), or by providing links through which the user may message the dealership through the dealership utility or through e-mail.

After the service has been scheduled, the user may then use the appointments interface (212), accessible through appointments button 330 in FIG. 3, to view information regarding scheduled appointments and schedule more service appointments if necessary. It will be appreciated that if the user calls or e-mails the dealership to schedule the service, the scheduled appointments may not be updated until an employee of the dealership inputs the appointment into the dealership utility, but if the user schedules the appointment through the calendar feature of the web, software, or mobile application, the dealership utility may be updated immediately.

By snoozing the outstanding notification 431, the user may prevent the notification from appearing for a predetermined amount of time. For example, the user may set a snooze time to be some length of time (such as 1 day, 2 days, 12 hours, etc.) in the notification settings interface (211), accessible through a button 334 from interfaces such as the vehicle status interface (210). The snooze button 431 may then use the user-selected (or a default length of time if the user did not designate one) snooze length before presenting that same notification (with an updated number of days remaining) to the user. In another embodiment, rather than setting a snooze length through the notification settings interface (211), clicking on the button 431 may bring up a set of options or an input form through which the user can select or input the amount of time that the user wishes to snooze the notification.

By dismissing the outstanding notification 432, the user may completely dismiss the notification and that particular notification will not be shown to the user again. In one embodiment, dismissing a 14-day advance notification for a next service due does not affect the 1-day advance notification for a next service due. In another embodiment, dismissing a notification for a next service due dismisses all notifications pertaining to that next service due date. In a further embodiment, the user may be given a choice to dismiss just the one notification or dismiss all related notifications. The user may also be provided with an option to submit a reason for dismissing the notification to the dealership. For example, if the user clicks the dismiss button 432, an input form or survey including a question asking the user for the reason of dismissal may be presented to the user. The user can then inform the dealership that the user is going to go elsewhere for the service, that the user is going to skip the service, that the user did the service himself, etc. The dealership may use this information to determine whether other notifications pertaining to that service being due should also be dismissed or not.

In a further embodiment, the dealership utility may automatically provide a coupon or promotion to the user if the user clicks dismiss 432 in order to try and persuade the user to schedule an appointment. The coupon or promotion may include a link to schedule a service. The dealership may also communicate with or provide a coupon or promotion to the user based on the reason for dismissal that the user inputs. For example, after reviewing the user's reason(s) for dismissal, the dealership may respond to the user's concerns through a message using the dealership utility (accessible through a messages interface provided in the customer module not depicted in the figures) or through e-mail or phone, as well as providing a discount or coupon to the user.

It will be appreciated that the user need not log-in exactly 14 days before the service to receive the 14-day advance notification. Although the dealership utility may be set as a default to e-mail, text, and provide notifications through the dealership utility at 14 days and 1 day before services are due and when actual services are scheduled, if the user does not log in for a while and logs in 10 days before a service is due, the outstanding notification (for the 14-day advance notification) depicted by FIG. 4 may still be presented to the user saying 10 days instead of 14 days. It will further be appreciated that other default time intervals may be used, that different intervals may be used for different events (e.g., 14-day and 1-day notifications for service due dates, and 5-day, 1-day and same-day notifications for scheduled appointments), and some notifications (such as provision of special promotions) need not occur some amount of days before a service due date. For example, a notification with a coupon may be presented to the user on the user's birthday.

In a further embodiment, the notification settings interface (211) may be used by the user to manually set notification times for the user (e.g. how many days before service appointments, scheduled appointments etc.), to select whether the user wishes to receive notifications by e-mail and/or text and/or at the dealership utility upon log-in, and to select whether the user wishes to receive coupons. It will be appreciated that the notification settings interface (211) may be combined with or subsumed within the account information interface (215), which is accessible through button 333 and may allow the user to review and update information such as the user's name, log-in information, vehicle information, contact information, various preferences associated with the user's account with the dealership utility, etc.

Another use of the notifications feature described above is to notify the user of when parts needed for a particular service have arrived. For example, if the user takes a vehicle in for an oil change and general check-up, and the dealership discovers a problem with one of the parts, the dealership may need to order a new part for the vehicle. When the part arrives at the dealership, the dealership may use the dealership utility to notify the customer that the part has arrived and provide them with the ability to schedule an appointment right away (or the dealership utility may automatically notify the customer once it receives confirmation that the ordered part has arrived). Similarly, if a user schedules a service appointment and indicates that a part (such as a battery) needs to be replaced, the dealership may check whether it has the necessary part in stock and if it is not in stock, may notify the customer that the part is not in stock, may cancel the customer's appointment if necessary, message the customer that it has ordered the part, and indicate that the customer will be notified when the part arrives.

It will be appreciated that a user may access the dealership utility from software or web applications from a computer, as well as accessing the dealership utility from a mobile application. Any action performed by the user at any implementation, whether web, software, or mobile, may be synced up with the other implementations of the dealership utility. Thus, if a user indicates that he wishes to dismiss a notification at a mobile application implementation of the dealership utility on the user's mobile device and the user subsequently logs onto the dealership utility from a home computer, the notification will not appear at the home computer since the notification has already been dismissed. The networked implementation of the dealership utility system 101 shown in FIG. 1 facilitates the synchronization of the various implementations, as actions performed by any application will update the database 104 such that any changes made by one implementation of the dealership utility on a computing device will be reflected accordingly in other implementations on other computing devices accessing the dealership utility system 101.

In another aspect of the dealership utility, the user may access a service history interface (214) that displays the dates and services performed on those dates of appointments previously scheduled with the dealership. This provides an efficient and organized way for customers to keep track of the services that have been performed on their vehicles and provides an incentive for them to consistently schedule appointments with the dealership so that a thorough service history may be established on the dealership utility. In a further embodiment, the dealership utility may allow the customer to upload documents such as receipts and service orders as proof of the service being performed, which may be advantageous to the customer if the customer later decides to sell the vehicle. It will be appreciated that the dealership may also use the dealer interface to upload these documents. In yet another further embodiment, the customer may be allowed to supplement the service history by adding records of services performed at other locations and services performed before signing up with the dealership utility, such that the customer can keep a complete service record on the dealership utility regardless of where and when the services are performed.

In yet another aspect of the dealership utility, the user may access a contact dealership interface (213), through a contact dealer button 331, and the dealership utility provides the user with dealership information such as hours of operation and one or more contact numbers. This interface may further provide roadside assistance numbers, emergency assistance numbers, and other types of assistance numbers to the user. In the mobile application implementation of the dealership utility, the contact numbers may be provided as links that, when clicked or selected, dial the corresponding phone number using the mobile phone.

It will be appreciated that in another further embodiment, the invention may also be implemented through a text messaging-based system, where communications between the dealership utility and users described herein are performed through text messages (e.g. the dealership utility sends text messages to a user's phone reminding the user that service is due, and the user may respond with a text message to schedule a service appointment). This may be particularly designed for users that have mobile phones that are not smartphones such that these users may use a combination of a web application or software application with mobile communication through text messages to receive reminders and set up appointments.

Turning now to the functionality that the dealership utility provides to dealers (i.e. individuals working at the dealership) through the dealer module 206, the interfaces available to a dealer will be described in detail. Many of these interfaces are related to the customer interfaces described above, but there are also dealer-specific interfaces that provide functionality related to management of employees and customers as well as overall business affairs. Upon a dealer's log-in from the dealer log-in interface 204, the default interface that is presented to the dealer may be any one of those described below, or may be a home interface that merely provides links to all the various interfaces described below. Additionally, it will be appreciated, as described above with the customer interfaces, that the various dealer interfaces may be designed to be combined with each other or subsumed within other interfaces in embodiments that vary from the particular exemplary embodiments depicted and described below.

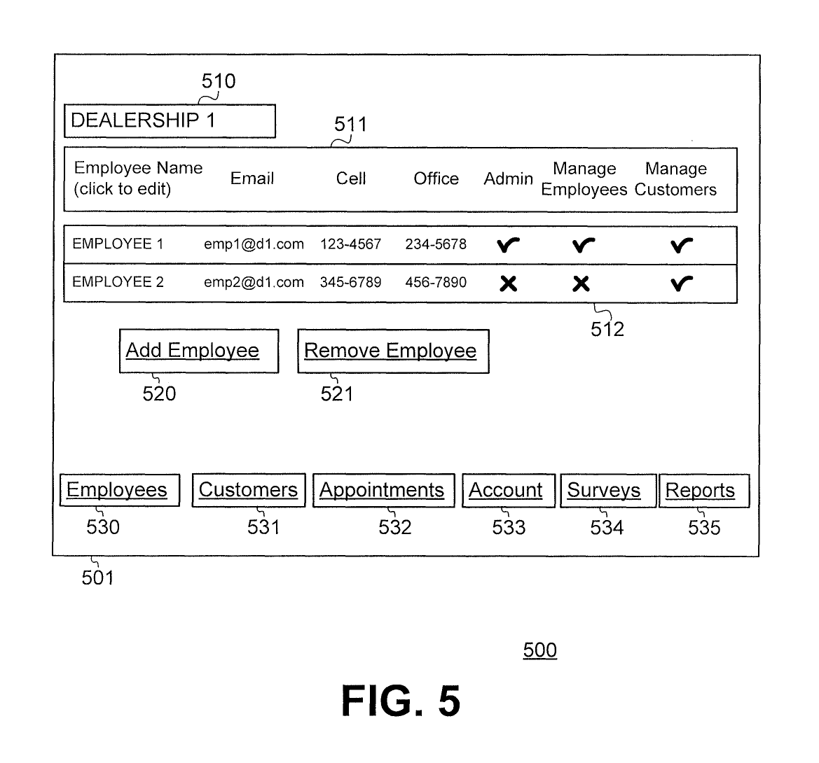

FIG. 5 depicts a diagram 500 of a display 501 corresponding to the employees interface (220) of the dealer module 206 in one exemplary embodiment. The display 501 includes an indication of the dealership name 510, DEALERSHIP 1; an employee information heading 511 including employee name (with instructions to click on an employee name to edit the details corresponding to that employee), contact information for the employee including e-mail, cell phone number, and office phone number (note that 7 digits are displayed for simplicity and to save space, but 10 digit phone numbers may be used), as well as permissions settings relating to the dealer module 206 of the dealership utility corresponding to the employees; a list of employees 512 with the information corresponding to each employee under the headings; an add employee button 520; a remove employee button 521; and a group of buttons 530-535 for accessing other dealer module interfaces. It will be appreciated that the employee interface need not only include the information shown, and may include additional information such as employee working shifts, titles, other contact information, and various other permissions (such as specific permissions for editing, adding, and deleting customers, different types of admin permissions, and permissions pertaining to different types of customers).

In the example depicted by FIG. 5, EMPLOYEE 1 is an admin and has permission to manage employees as well as manage customers. Thus, EMPLOYEE 1 may click on the add employee button 520 and input additional employee information into a new employee input interface and add a third employee to the list of employees 512. Similarly, EMPLOYEE 1 may click on the remove employee button 521 and remove a listed employee. EMPLOYEE 1 may also click on the names of EMPLOYEE 1 or EMPLOYEE 2 to modify the employee information stored for each employee. It will be appreciated that EMPLOYEE 2, which does not have permission to manage employees, may be prohibited from making changes to employee information or adding and removing employees.

It will be appreciated that, similar to the customer interfaces, the exact manner of presentation is not important so long as the functionality described herein is provided in a practical and readily understandable way. FIG. 5 is intended to be an exemplary depiction of a possible employees interface (220) and is not intended to impart any limitation regarding the design or layout of the interface.

In another aspect of the dealer module 206 of the dealership utility, accessible by clicking on the “customers” button 531, a dealer may access the customers interface (221) which provides a list of customers that may include the customers' contact information, as well as vehicle information corresponding to those customers. The customers interface (221) may also allow dealers (having suitable permissions) to add, remove, or modify customer records and to contact the customers. It is not a requirement for a customer to have his or her own user account with the dealership utility for the dealer to add a new customer to the customer list, but if a customer does have an account with the dealership utility (or subsequently creates an account), the customer records in the dealer module 206 may be linked to the customer account information from the customer module 205 such that updates to the customer's vehicle and contact information by either the customer or the dealer are reflected in the other module. The customers interface (221) may further provide search functionality that allows a dealer to search for a particular customer by name, contact information, or vehicle information, which is particularly helpful for dealerships having a large customer base.

In yet another aspect of the dealer module 206 of the dealership utility, accessible by clicking on the “appointments” button 532, a dealer may access the appointments interface (222) which provides a list of the dates and services requested or performed with respect to scheduled and completed service appointments, billing information corresponding to completed service appointments (e.g. how much was charged and whether the customer has paid in full), as well as information regarding the customers that requested or received those services. The list of appointments may further allow the dealer viewing the list to filter appointments by time period, to view completed appointments, canceled appointments, incomplete appointments or scheduled appointments, to search for appointments corresponding to a certain customer or vehicle, etc. It will be appreciated that when customers schedule an appointment through the appointments interface of the customer module 205 of the dealership utility, the scheduled appointments may automatically appear in the list of scheduled appointments accessed from the dealer module 206. The dealer may further use the appointments interface to schedule services for customers that called the dealer, e-mailed the dealer or otherwise contacted the dealer to schedule a service appointment (e.g., through the calendar input method described above with respect to clients). The appointments page also allows the dealer to notify a customer through an email message, a text message, or other type of electronic message that a particular service is complete and the total due (or total paid), if any.

In yet another aspect of the dealer module 206 of the dealership utility, accessible by clicking on the “account” button 533, a dealer may access the customers interface (221), through which the dealer may view or update the account information with which they registered, such as, for example, dealership name, contact information, hours of operation, certain user preferences and default settings, manually restart the countdown to next service portion of the program, etc.

In yet another aspect of the dealer module 206 of the dealership utility, accessible by clicking on the “surveys” button 534, a dealer may access a surveys interface (224) pertaining to surveys completed by customers and submitted to the dealership utility. For example, customers may be asked to fill out surveys (either through the customer module 205 of the dealership utility or on paper and uploaded through the dealer module 206 of the dealership utility) regarding events such as new and used vehicle purchases, scheduled service appointments, reasons for canceling an appointment or dismissing a service notification reminder, or to rate their general satisfaction with the dealership or the dealership utility. These survey responses and any corresponding survey scores may be compiled and viewed at the surveys interface to assist the dealership or dealership utility with improving customer satisfaction in areas where customer survey ratings are low, and to assist the dealership with marketing by using survey quotations praising the dealership or dealership utility.

In yet another aspect of the dealer module 206 of the dealership utility, accessible by clicking on the “reports” button 535, a dealer may access reports interface (225) which may provide various reports regarding dealer activities based on user-specified criteria. For example, the dealer may view reports regarding scheduled and completed appointments, service parts ordered (e.g. special order parts (SPOs)), revenue associated with completed appointments, marketing campaigns (e.g. number of services scheduled in response to promotion notifications), and communications with customers (e.g. number of times customers used the mobile application to call the dealership). The dealer may further generate reports filtered by specific date ranges or other criteria, such as viewing reports regarding missed appointments and service appointments scheduled through different means (e.g. through calling, through the web application, through the mobile application, etc.). Additionally, by viewing reports showing the number of services and revenue earned on services scheduled by users through the web application, software application, or mobile application implementations of the dealership utility, the dealer may assess the ROI (return on investment) provided to the dealership by the dealership utility.

It will be appreciated that the dealership utility may also accommodate dealers having multiple stores by either consolidating all the employee, customer, and appointments data into a combined dealer module 206, or by providing separate dealer modules for each store. A dealership having multiple stores may toggle through the different stores by, for example, using a “switch store” button. Furthermore, dealerships may group certain stores geographically such that one dealer module may combine the records of a few stores located in one geographic region while another dealer module for the same dealership combines the records of a few stores located in another geographic region.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for providing dealership services to customers of a dealership, comprising:
receiving, at a computing device, log-in information corresponding to a customer of the dealership;
estimating, at the computing device, a distance traveled corresponding to a vehicle associated with the customer according to a database at the dealership utility system;
determining, at the computing device, a next service due time based on the estimated distance traveled;
notifying, from the computing device, the customer at a predetermined time prior to the determined next service due time of when the vehicle is due for a service; and
receiving, at the computing device, an input from the customer corresponding to scheduling of a service appointment in response to the notification.

2. The method of claim 1, further comprising:
receiving, at the computing device, at least two distance traveled inputs corresponding to the distance traveled corresponding to the vehicle, wherein the at least two distance traveled inputs are received at different times;
calculating, at the computing device, a predictive distance over time rate based on the at least two distance traveled inputs and the times at which the at least two distance traveled inputs were received; and
wherein estimating the distance traveled corresponding to the vehicle further comprises:
applying the predictive distance over time rate to one of an estimated distance traveled and a received distance traveled input.

3. The method of claim 1, wherein estimating the distance traveled corresponding to the vehicle further comprises:
applying a default distance over time rate to a previously stored distance traveled value corresponding to the vehicle.

4. The method of claim 1, further comprising:
notifying, from the computing device, the customer of a scheduled service appointment at a predetermined time prior to the scheduled service appointment.

5. The method of claim 1, further comprising:
communicating, from the computing device, a vehicle status corresponding to the vehicle, wherein the vehicle status includes the estimated distance traveled and the next service due time.

6. The method of claim 1, further comprising:
communicating, from the computing device, information corresponding to at least one of future scheduled service appointments and past services performed by the dealership on the vehicle to the customer.

7. The method of claim 1, wherein the computing device is one of a personal computer, tablet computer, a mobile phone, and an application server.

8. A system for providing dealership services to customers of a dealership, comprising at least one computing device connected to a network having at least one tangible non-transient computer-readable medium with computer-executable instructions stored thereon, the computer-executable instructions comprising:
instructions for receiving log-in information corresponding to a customer of the dealership;
instructions for estimating a distance traveled corresponding to a vehicle associated with the customer according to a database at the dealership utility system;
instructions for determining a next service due time based on the estimated distance traveled;
instructions for notifying the customer at a predetermined time prior to the determined next service due time of when the vehicle is due for a service; and
instructions for receiving an input from the customer corresponding to scheduling of a service appointment in response to the notification.

9. The system of claim 8, wherein the computer-executable instructions further comprise:
instructions for receiving at least two distance traveled inputs corresponding to the distance traveled corresponding to the vehicle, wherein the at least two distance traveled inputs are received at different times;
instructions for calculating a predictive distance over time rate based on the at least two distance traveled inputs and the times at which the at least two distance traveled inputs were received; and
wherein the instructions for estimating the distance traveled corresponding to the vehicle further comprise:
instructions for applying the predictive distance over time rate to one of an estimated distance traveled and a received distance traveled input.

10. The system of claim 8, wherein the instructions for estimating the distance traveled corresponding to the vehicle further comprise:
instructions for applying a default distance over time rate to a previously stored distance traveled value corresponding to the vehicle.

11. The system of claim 8, wherein the computer-executable instructions further comprise:
instructions for notifying the customer of a scheduled service appointment at a predetermined time prior to the scheduled service appointment.

12. The system of claim 8, wherein the computer-executable instructions further comprise:
instructions for communicating a vehicle status corresponding to the vehicle, wherein the vehicle status includes the estimated distance traveled and the next service due time.

13. The system of claim 8, wherein the computer-executable instructions further comprise:
instructions for communicating information corresponding to at least one of future scheduled service appointments and past services performed by the dealership on the vehicle to the customer.

14. A networked dealership utility system, comprising:
at least one web server, application server, and database having computer-executable instructions stored on at least one tangible non-transient computer-readable medium, wherein the computer-executable instructions, when executed, provide a customer module to customers accessing the networked dealership utility system and a dealer module to dealers accessing the dealership utility system, wherein:
the customer module further comprises:
a vehicle status interface for providing a customer with an estimated distance traveled and a next service due time corresponding to a vehicle associated with the customer;
a notifications interface for notifying the customer of at least one of a next service due time, a scheduled appointment, and a marketing promotion; and
a customer appointments interface for scheduling an appointment for the customer; and
the dealer module further comprises:
a customers interface for viewing a list of customer records, adding new customer records, and removing and modifying existing customer records; and
a dealer appointments interface for viewing a list of appointments, including scheduled and completed appointments, adding new scheduled appointments, and canceling appointments.

15. The system of claim 14, wherein appointments scheduled using the customer appointments interface are automatically included in the list of appointments corresponding to the dealer appointments interface.

16. The system of claim 14, wherein the dealer module further comprises:
an employees interface for viewing a list of employee records including contact information, and permissions information, for adding new employee records, and for removing and modifying existing employee records.

17. The system of claim 14, wherein the dealer module further comprises:
a surveys interface for viewing at least one of surveys and survey results received from customers.

18. The system of claim 14, wherein the dealer module further comprises:
a reports interface for viewing reports relating to dealer activities based on user-specified criteria.

19. The system of claim 14, wherein the dealer appointments interface is further for notifying customers of completed service and costs due.

20. The system of claim 14, wherein the computer-executable instructions, when executed, further provide a customer log-in interface for accessing the customer module and a dealer log-in interface for accessing the dealer module.
